(19) United States
(12) Patent Application Publication
(10) Pub. No.: US 2025/0097870 A1
(43) Pub. Date: Mar. 20, 2025

(54) METHODS AND APPARATUSES OF WIRELESS COMMUNICATION IN NON-TERRESTRIAL NETWORK

(71) Applicant: Lenovo (Beijing) Limited, Beijing (CN)

(72) Inventors: Min Xu, Beijing (CN); Hongmei Liu, Beijing (CN); Jing Han, Beijing (CN); Lianhai Wu, Beijing (CN); Ran Yue, Beijing (CN); Jie Hu, Beijing (CN)

(73) Assignee: Lenovo (Beijing) Limited, Beijing (CN)

(21) Appl. No.: 18/729,317

(22) PCT Filed: Jan. 21, 2022
(86) PCT No.: PCT/CN2022/073212

§ 371 Date: Jul. 16, 2024

(51) Int. Cl. H04W 56/00; H04W 28/06; H04W 84/06

(52) U.S. Cl. CPC H04W 56/0045; H04W 28/06; H04W 56/0025; H04W 84/06

(57) ABSTRACT

The present application relates to methods and apparatuses for wireless communication in non-terrestrial network. One embodiment of the present disclosure provides a radio access network (RAN) node, may include: a transceiver; and a processor, wherein the processor is configured to: determine first time information associated with a neighbor RAN node of the RAN node; and transmit the first time information to a user equipment (UE), wherein the first time information includes at least one of: a first epoch time associated with the neighbor RAN node; or a first validity time associated with the neighbor RAN node.

### TECHNICAL FIELD

The present disclosure relates to relate to wireless communication technology, and more particularly, relates to methods and apparatuses of wireless communication in non-terrestrial network (NTN), e.g., for time-related status determination of a neighbor radio access network (RAN) node in NTN.

### BACKGROUND OF THE INVENTION

Serving satellite or high altitude platform station (HAPS) ephemeris and common timing advance (TA) are necessary at user equipment (UE) for the uplink time synchronization. Neighbor satellite or HAPS ephemeris is also necessary at UE in propagation delay estimation, to assist measurement window (or gap) configuration and/or time-based cell reselection.

To calculate the current accurate and valid position of a neighbor satellite or HAPS and thus the propagation delay between the UE and a neighbor satellite or HAPS, the UE needs to know the epoch time and the validity time duration associated with neighbor satellite or HAPS ephemeris. Meanwhile if uplink synchronization to a neighbor satellite or HAPS is needed (e.g., handover to a neighbor cell that belongs to a neighbor satellite or HAPS), the UE also needs to know the epoch time and the validity time duration associated with neighbor satellite or HAPS common TA, feeder link delay or velocity etc.

However, it is rather difficult for the UE to obtain the above time-related status of the neighbor satellite or HAPS, and it is desirable to provide solutions for solving the above issue.

### SUMMARY

An embodiment of the present disclosure provides a radio access network (RAN) node, which may include: a transceiver; and a processor, wherein the processor is configured to: determine first time information associated with a neighbor RAN node of the RAN node; and transmit the first time information to a UE, wherein the first time information includes at least one of: a first epoch time associated with the neighbor RAN node; or a first validity time associated with the neighbor RAN node.

In some embodiments, the first time information is determined based on second time information of the neighbor RAN node, wherein the second time information at least may include one of the following: a second epoch time associated with the neighbor RAN node; or a second validity time associated with the neighbor RAN node.

In some embodiments, the second time information is pre-stored in the RAN node, or received from the neighbor RAN node in response to a request from the RAN node to the neighbor RAN node.

In some embodiments, the request may include at least one of: an indication to request a part of the second time information or all of the second time information; an identity of the neighbor RAN node; or a preferred format of the second time information.

In some embodiments, the first time information is represented in a first format, the second time information is represented in a second format, and the processor is further configured to: convert the second time information in the second format to the first time information in the first format.

In some embodiments, the first time information is represented by one or more difference values compared to the second time information.

In some embodiments, at least one the first epoch time or the first validity time is associated with at least one of: an ephemeris of the neighbor RAN node; a common TA of the neighbor RAN node; or a feeder link propagation delay of the neighbor RAN node.

In some embodiments, the first time information may further include a first reference time point for at least one of the first epoch time or the first validity time.

In some embodiments, the first time information is transmitted to the UE by a system information (SI) broadcast, an on-demand SI, or a dedicated signaling.

In some embodiments, the first time information indicates at least one of the following: the first epoch time has a same value as a third epoch time associated with the RAN node, wherein the third epoch time is associated with at least one of an ephemeris of the RAN node or a common TA of the RAN node; or the first validity time has a same value as a third validity time associated with the RAN node, wherein the third validity time is associated with at least one of an ephemeris of the RAN node or a common TA of the RAN node.

Another embodiment of the present disclosure provides a UE, which may include: a transceiver; and a processor, wherein the processor is configured to: receive, from a RAN node, first time information associated with a neighbor RAN node of the RAN node, and determine time-related status of the neighbor RAN node based on the first time information; wherein the first time information includes at least one of: a first epoch time associated with the neighbor RAN node; or a first validity time associated with the neighbor RAN node.

In some embodiments, at least one the first epoch time or the first validity time is associated with at least one of the following: an ephemeris of the neighbor RAN node; a common TA of the neighbor RAN node; or a feeder link propagation delay of the neighbor RAN node.

In some embodiments, the first time information may further include a first reference time point for at least one the first epoch time or the first validity time.

In some embodiments, the first time information is received by an SI broadcast, an on-demand SI, or a dedicated signaling.

In some embodiments, the time-related status of the neighbor RAN node may include at least one of the following: at least one of the ephemeris, the common TA, or the feeder link propagation delay at the first epoch time; at least one of the ephemeris, the common TA, or the feeder link propagation delay that is valid; at least one of the ephemeris, the common TA, or the feeder link propagation delay at a given time; coordinates of the neighbor RAN node at a given time; an orbital position of the neighbor RAN node at a given time; a validity timer for the neighbor RAN node parameter values that is started the first time information is received; a length of the validity timer from reception time to the first validity time; the first epoch time has a same value as a third epoch time associated with the RAN node, wherein the third epoch time is associated with at least one of an ephemeris of the RAN node or a common TA of the RAN node; or the first validity time has a same value as a third validity time associated with the RAN node, wherein the third validity time is associated with at least one of an ephemeris of the RAN node or a common TA of the RAN node.

In some embodiments, in the case that the first time information may include the first validity time, the processor is further configured to perform at least one of: discard received first time information associated with the neighbor RAN node when the first validity time expires; discard determined time-related status based on the first time information when the first validity time expires; or request for updating the first time information associated with the neighbor RAN node when the first validity time expires.

Yet another embodiment of the present disclosure provides a method performed by a RAN node, may include: determining first time information associated with a neighbor RAN node of the RAN node; and transmitting the first time information to a UE, wherein the first time information includes at least one of: a first epoch time associated with the neighbor RAN node; or a first validity time associated with the neighbor RAN node.

In some embodiments, the first time information is determined based on second time information of the neighbor RAN node, wherein the second time information at least may include one of the following: a second epoch time associated with the neighbor RAN node; or a second validity time associated with the neighbor RAN node.

In some embodiments, the second time information is pre-stored in the RAN node, or received from the neighbor RAN node in response to a request from the RAN node to the neighbor RAN node.

In some embodiments, the request may include at least one of: an indication to request a part of the second time information or all of the second time information; an identity of the neighbor RAN node; or a preferred format of the second time information.

In some embodiments, the first time information is represented in a first format, the second time information is represented in a second format, and the method furthering may include: converting the second time information in the second format to the first time information in the first format.

In some embodiments, the first time information is represented by one or more difference values compared to the second time information.

In some embodiments, at least one the first epoch time or the first validity time is associated with at least one of: an ephemeris of the neighbor RAN node; a common TA of the neighbor RAN node; or a feeder link propagation delay of the neighbor RAN node.

In some embodiments, the first time information may further include a first reference time point for at least one of the first epoch time or the first validity time.

In some embodiments, the first time information is transmitted to the UE by an SI broadcast, an on-demand SI, or a dedicated signaling.

In some embodiments, the first time information indicates at least one of the following: the first epoch time has a same value as a third epoch time associated with the RAN node, wherein the third epoch time is associated with at least one of an ephemeris of the RAN node or a common TA of the RAN node; or the first validity time has a same value as a third validity time associated with the RAN node, wherein the third validity time is associated with at least one of an ephemeris of the RAN node or a common TA of the RAN node.

Yet another embodiment of the present disclosure provides a method performed by a UE, which may include: receive, from a RAN node, first time information associated with a neighbor RAN node of the RAN node, and determine time-related status of the neighbor RAN node based on the first time information; wherein the first time information includes at least one of: a first epoch time associated with the neighbor RAN node; or a first validity time associated with the neighbor RAN node.

In some embodiments, at least one the first epoch time or the first validity time is associated with at least one of the following: an ephemeris of the neighbor RAN node; a common TA of the neighbor RAN node; or a feeder link propagation delay of the neighbor RAN node.

In some embodiments, the first time information may further include a first reference time point for at least one the first epoch time or the first validity time.

In some embodiments, the first time information is received by an SI broadcast, an on-demand SI, or a dedicated signaling.

In some embodiments, the time-related status of the neighbor RAN node may include at least one of the following: at least one of the ephemeris, the common TA, or the feeder link propagation delay at the first epoch time; at least one of the ephemeris, the common TA, or the feeder link propagation delay that is valid; at least one of the ephemeris, the common TA, or the feeder link propagation delay at a given time; coordinates of the neighbor RAN node at a given time; an orbital position of the neighbor RAN node at a given time; a validity timer for the neighbor RAN node parameter values that is started the first time information is received; a length of the validity timer from reception time to the first validity time; the first epoch time has a same value as a third epoch time associated with the RAN node, wherein the third epoch time is associated with at least one of an ephemeris of the RAN node or a common TA of the RAN node; or the first validity time has a same value as a third validity time associated with the RAN node, wherein the third validity time is associated with at least one of an ephemeris of the RAN node or a common TA of the RAN node.

In some embodiments, in the case that the first time information may include the first validity time, the method may further include at least one of: discarding received first time information associated with the neighbor RAN node when the first validity time expires; discarding determined time-related status based on the first time information when the first validity time expires; or requesting for updating the first time information associated with the neighbor RAN node when the first validity time expires.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIGS. 1A and 1B respectively illustrate two exemplary satellite ephemeris formats according to some embodiments of the present disclosure.

FIGS. 2A-2C illustrate the serving satellite information associated with epoch time and a validity time duration according to some embodiments of the present disclosure.

FIG. 3 illustrates a method for the UE to obtain the epoch time and validity time duration of the neighbor RAN node.

FIG. 4 illustrates a method for the UE to obtain the epoch time and validity time duration of the neighbor RAN node according to some embodiments of the present disclosure.

FIG. 5 illustrates a flow chart of an exemplary procedure of wireless communications according to some embodiments of the present disclosure.

FIG. 6 illustrates a block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

NTN refers to a network, or segment of networks using radio frequency (RF) resources on board a satellite or an HAPS. The satellite in NTN may be a geostationary earth orbiting (GEO) satellite with fixed location to the Earth, or a low earth orbiting (LEO) satellite orbiting around the Earth. The HAPS in NTN may be an aircraft or a balloon. In 3GPP Rel-17 NTN using NR air interface is discussed in the work item “Solutions for NR to support NTN” and NTN using LTE air interface for IoT UEs is discussed in the work item “Study on NB-IoT/eMTC support for NTN”. In NTN, similarly to a terrestrial BS or access node (AN), both the satellite and HAPS can also be referred to as a RAN node. In some embodiments of the present disclosure, the satellite or HAPS may only act as an access node, while in some other embodiments of the present disclosure, the satellite or the HAPS may also act as a BS.

In NTN especially that with LEO, fast moving satellites, the ephemeris data is used to indicate the trajectories and position coordinates of satellite. Serving satellite ephemeris can be indicated to UE to calculate the distance to the satellite and thus the propagation delay can be determined, which is essential for uplink time synchronization in NTN. The ephemeris can also be used to calculate satellite velocity to the UE, which is essential for uplink frequency synchronization. That is the same for the HAPS in NTN.

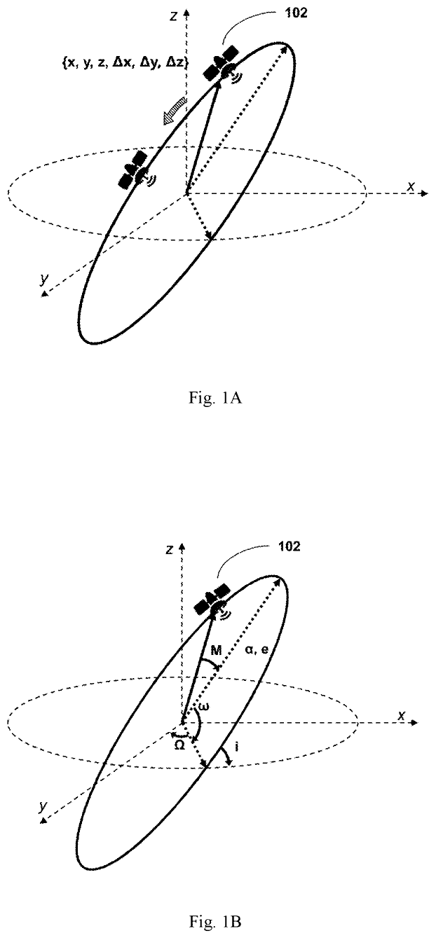

FIGS. 1A and 1B respectively illustrate two exemplary satellite ephemeris formats according to some embodiments of the present disclosure. For satellite systems with satellite, either one format or both formats can apply, while for an HAPS without an orbit as the satellites, only the position and velocity state vector ephemeris format is applied.

Specifically, in FIG. 1A, the satellite 102 is orbiting around the Earth. The origin of the coordinate system is the center of the Earth. The coordinate system has three axes, the x axis, the y axis, and the z axis.

FIG. 1A depicts the position and velocity state vector ephemeris format, wherein, the satellite ephemeris is represented by the position and the velocity state vector {x, y, z, Δx, Δy, Δz}, and
x is the coordinate value on the x-axis;
y is the coordinate value on the y-axis;
z is the coordinate value on the z-axis;
Δx is the velocity value on the x-axis;
Δy is the velocity value on the y-axis; and
Δz is the velocity value on the z-axis.

The payload size for position and velocity state vector ephemeris format is 17 Bytes, i.e. 17×8=136 bits. Within the 136 bits, 78 bits are for position (with the unit of meter (m)), i.e., the parameters {x, y, z}. The position range is determined by GEO with the range from −42200 kilometer (km) to +42200 km. The quantization step is 1.3 m for position. 54 bits are for velocity, with the unit of meter per second (m/s), and the velocity range is determined by LEO@600 km with the range from −8000 m/s to +8000 m/s.

FIG. 1B depicts the orbital parameter ephemeris format. That is, the satellite ephemeris is represented with orbital parameters. In FIG. 1B, the satellite 102 is a GEO satellite with fixed location to the Earth. The origin of the coordinate system is the center of the Earth. The coordinate system has three axes, the x axis, the y axis, and the z axis. The payload size for position and velocity state vector ephemeris format is 18 Bytes, i.e., 18×8=144 bits. The orbital parameters include:
1) Semi-major axis α, the unit of the semi-major axis is m, the bit size for semi-major axis is 33 bits, and the value of α ranges from 6500 km to 43000 km;
2) Eccentricity e, the bit size for eccentricity is 19 bits, and the value of eccentricity is not larger than 0.015, i.e. ≤0.015;
3) Argument of periapsis ω, the unit of the argument of periapsis is rad, the bit size of argument of periapsis is 24 bits, and the value of ω ranges from 0 to 2π;
4) Longitude of ascending node Ω, the unit of the longitude of ascending node is rad, the bit size of longitude of ascending node is 21 bits, and the value of Ω ranges from 0 to 2π;
5) Inclination i, the unit of inclination is rad, the bit size of the inclination is 20 bits, and the value of i ranges from −π/2 to +π/2;
6) Mean anomaly M at epoch time, the unit the mean anomaly is rad, of the bit size of mean anomaly is 24 bits, and the value of M ranges from 0 to 2π.

For the moving satellites or HAPS, part or all of the parameters in the ephemeris vary over time. With satellite (or HAPS) ephemeris associated with a time point (namely epoch time) provided, UE can calculate the satellite (or HAPS) position at current or future time point as long as it is valid. To ensure the accuracy and validity of UE calculation, 3GPP RAN1 confirmed that it is necessary to provide the epoch time and the validity time duration of the serving satellite (or HAPS) ephemeris to the UE. Other information related to uplink time synchronization, including the common TA and its changing rate, can also be indicated with the epoch time and the validity time duration to guarantee accuracy and validity of the uplink time synchronization.

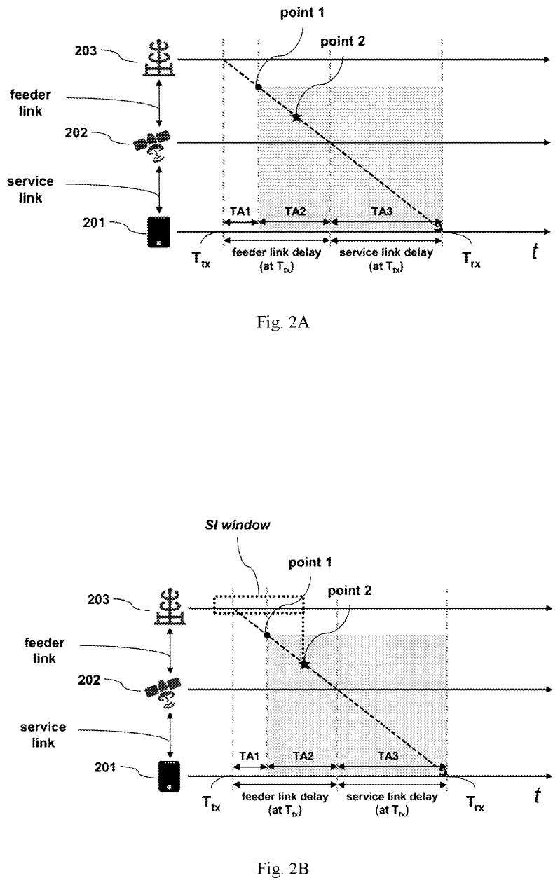

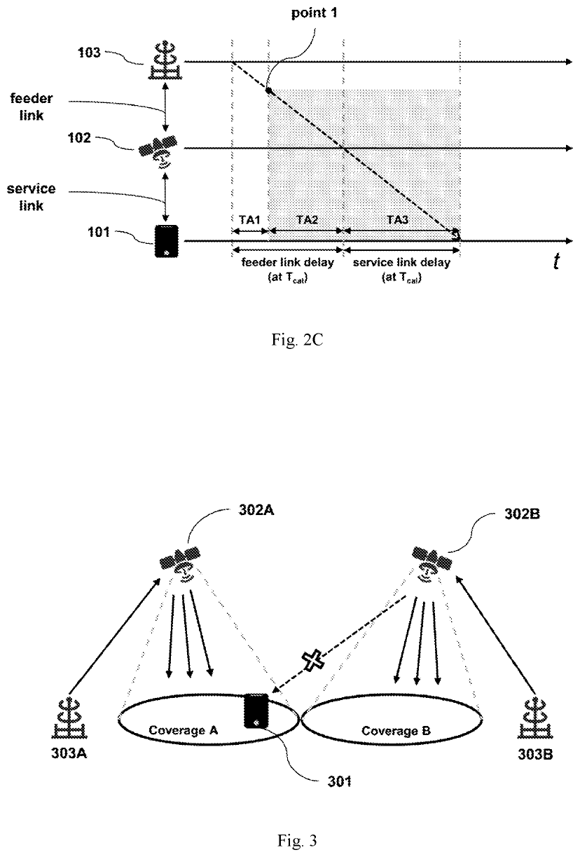

FIGS. 2A-2C illustrate the serving satellite information associated with epoch time and a validity time duration according to some embodiments of the present disclosure.

There are three components shown in FIG. 2A, a UE 201, a satellite 202, and a BS 203, wherein the BS 203 is the serving BS of the UE 201 and the satellite 202 is the serving satellite of the UE 201. The link between the BS 203 and the satellite 202 is referred to as a feeder link, and the link between the satellite 202 and the UE 201 is referred to as a service link. Point 1 refers to the uplink (UL) sync reference point, and point 2 refers to the epoch time. TA1 is half network (NW) compensated TA, which is a constant value, TA2 is half common TA at time Tₜₓ, and TA 3 is half specific UE-specific at time Tₜₓ.

At time Tₜₓ, the network, e.g., the BE 203 transmits at least one of a serving satellite ephemeris or a common TA associated with epoch time and a validity time duration to the UE 201, and UE 201 receives the same at time Tᵣₓ, which is approximately equal to

Tᵣₓ=Tₜₓ+service link delay at Tₜₓ+feeder link delay at Tₜₓ

The service link delay (i.e. TA3), is half of UE-specific TA at Tₜₓ, and the feeder link delay (i.e. TA1 (a constant value) and TA 2 at Tₜₓ) is half of common TA and network compensated TA. The common TA and the network compensated TA are divided by the reference point between the BS 203 and the satellite 202, which is referred to as the uplink time synchronization reference point, i.e., point 1.

Regarding the details of presenting the epoch time and the validity time of the serving satellite, 3GPP RAN1 made the following agreements:
The serving satellite ephemeris and common TA related parameters are signaled in the same SIB message and have the same epoch time.
Universal time coordinated (UTC) is not provided to define the epoch time.
The reference point for epoch time of the serving satellite ephemeris and Common TA parameters is the uplink time synchronization reference point and should be known by UE.
   When explicitly provided through SIB1 or dedicated signaling, epoch time of assistance information is the starting time of a downlink sub-frame, indicated by a SFN and a sub-frame number signaled together with the assistance information.
   When indicated in system information block (SIB) other than SIB1, epoch time of assistance information is implicitly known as the end of the SI window during which the SI message is transmitted.
NTN ephemeris validity timer should be started/restarted with configured timer validity time duration at the epoch time of the assistance information (i.e. serving satellite ephemeris data).

According to the above agreements, the epoch time, i.e., point 2 in FIG. 2A, may be explicitly provided to the UE 201 through SIB1 or dedicated signaling, or implicitly known as the end of the SI window.

That is, the epoch time, i.e., point 2, is indicated by a system frame number (SFN) and a sub-frame number signaled together with the assistance information.

Referring to FIG. 2B, the epoch time, i.e., point 2, is the end of the SI window during which the SI message is transmitted.

As shown in FIG. 2C, upon receiving at least one of the serving satellite ephemeris or common TA associated with the epoch time and a validity time duration, UE considers that the received parameter values are associated with the epoch time with the indicated validity time duration starting from it. As shown in FIG. 2C, with the received information, the UE can calculate the latest serving satellite position as well as its common TA due to the movement of at least one satellite or UE at a time T_{cal} during the validity time duration.

Specifically, at time T_{cal}, at least one of the serving satellite ephemeris or common TA at a time T_{cal} is calculated based on the at least one of phemeris or common TA at time Tₜₓ.

Although for uplink frequency synchronization there is no final RAN1 agreement related to the epoch time and validity time duration, it is expected that the epoch time and validity time duration are also important to calculate the accurate and valid frequency point or band at a given time considering the large Doppler shift caused by satellite (or HAPS) movement.

From RAN1's perspective, serving satellite (or HAPS) ephemeris and common TA are necessary at UE for uplink time synchronization. From RAN2's perspective, neighbor satellite (HAPS) ephemeris is also necessary at UE in propagation delay estimation, to assist measurement window (or gap) configuration and/or time-based cell reselection etc.

To calculate the current accurate and valid position of a neighbor satellite and thus determine the propagation delay between a UE and a neighbor satellite (or HAPS), the UE needs to know the epoch time and the validity time duration associated with neighbor satellite (or HAPS) ephemeris. Meanwhile, if the uplink synchronization to a neighbor satellite (or HAPS) is needed (e.g., handover to a neighbor cell that belongs to a neighbor satellite), the UE also needs to know the epoch time and the validity time duration associated with the common TA, feeder link delay or velocity, etc., time-related status of the neighbor satellite (or HAPS).

FIG. 3 illustrates a method for the UE to obtain the epoch time and validity time duration of the neighbor RAN node according to some embodiment of the present disclosure. The neighbor RAN node may be a satellite or an HAPS in NTN, and a satellite is illustrated as an example herein. The following illustrated solution concerning on the satellite is also adaptive to the HAPS.

FIG. 3 illustrates a UE 301, a serving satellite 302A of the UE 301, a neighbor satellite 302B of the UE 301, a serving BS 303A of the UE 301, and a neighbor BS 303B of the UE 301. The coverage area A is covered by the serving satellite 302A, and the coverage area B is covered by the neighbor satellite 302B. Although the serving satellite 302A and serving BS 303B are separate shown in FIG. 3, persons skilled in the art should well know that they can be combined into one, e.g., the serving satellite 302A acting as a BS itself. That is the same for the neighbor satellite 302B and neighbor BS 303B. In the other words, although in FIG. 3, the serving BS 303A (or the neighbor BS 303B) and the serving satellite 302A (or the neighbor satellite 302B) are located in different locations or apparatuses, in some other scenarios, the serving BS 303A (or the neighbor BS 303B) and the serving satellite 302A (or the neighbor satellite 302B) may be located in the same location or apparatus. In addition, the serving satellite 302 A and neighbor satellite 302B may be neighbor satellites, they may be referred to as other relations, such as nearby satellites, or the like.

The serving satellite 302A may broadcast SI to the UEs within coverage A, which may include the epoch time and validity time duration of the serving satellite, i.e. the epoch time and validity time duration of the serving satellite 302A. To obtain the epoch time and validity time duration of the neighbor RAN node, e.g., the neighbor satellite 302B, the UE 301 may need to satisfy the following conditions:
1) be covered by a neighbor RAN node, e.g., a satellite or HAPS;
2) be configured with an appropriate measurement gap and SSB measurement timing configuration (SMTC) window; and
3) measure the timing deviation between the two kinds of frames with configured SFN and frame boundary timing difference (SFTD) window, if the neighbor RAN node, e.g., a satellite or HAPS uses different radio access technology (RAT) from the serving RAN node.
Regarding condition 1), in addition to being covered by the serving satellite (or HAPS, hereafter the same), the UE needs to be covered by the neighbor satellite at the same time. That is, in FIG. 3, the UE 301 needs to be located within the intersection area of coverage A and coverage B. However, under a quasi-Earth-fixed scenario, a neighbor satellite only starts to cover the same area of the serving satellite when it stops to cover. That is also true for the discontinuous coverage scenario with sparse satellite constellation. That is, the UE being covered by both the serving satellite and the neighbor satellite at the same time cannot occur under the quasi-Earth-fixed scenario.
Regarding condition 2), to perform RF switch for reception from a neighbor satellite, the UE needs to be configured with measurement gap and SMTC. However, the network may not configure an appropriate measurement gap or SMTC window without knowledge of the propagation delay between the UE and a neighbor satellite which needs to be calculated based on neighbor satellite ephemeris.
Regarding condition 3), if a neighbor satellite uses different RATs from the serving satellite (e.g., NR and LTE), the UE needs to measure the timing deviation between the two kinds of frames with the configured SFTD window. Similar as discussed in RAN2, the network may not configure an appropriate SFTD window without knowledge of the propagation delay between the UE and neighbor satellite.

Besides, even with fulfilled conditions 1), 2), and 3) (e.g. a UE in Earth-moving scenario is configured with appropriate measurement gap and SMTC/SFTD window in coincidence), the UE needs to at least receive the master information block (MIB) and SIB1 of the neighbor satellite if the necessary information is included in SIB1, and it may need to consume more power to receive other SIBs that includes the necessary information. In some other embodiments of the present application, the satellite ephemeris and other related information may be included in a new SIB (e.g., SIBx) other than SIB1, and in this case the UE needs to receive the MIB, SIB1 and SIBx, which is inefficient in power consumption.

Similarly if uplink synchronization to a neighbor RAN node, e.g., a satellite or a HAPS is needed, it is impossible or inefficient for a UE to directly acquire the common TA, feeder link delay or velocity of the neighbor RAN node from the broadcasting of the neighbor RAN node.

In addition, the information of the neighbor satellite (or HAPS) may be represented in the format of frame and sub-frame number is used instead of absolute UTC time. When the neighbor RAN node uses a different RAT from that of the serving RAN node, format converting may also be needed.

Therefore, embodiments of the present disclosure propose solutions of providing time information (at least include at least one of the epoch time or validity time) associated with a neighbor RAN node, e.g., a neighbor satellite or neighbor HAPS to the UE by the serving RAN node, e.g., a serving BS, which is not restricted by the above conditions. Furthermore, the time information may be provided by the serving RAN node with necessary processing (e.g. format conversion) so that the UE can obtain it without neighbor RAN node's coverage and can directly use it for calculation.

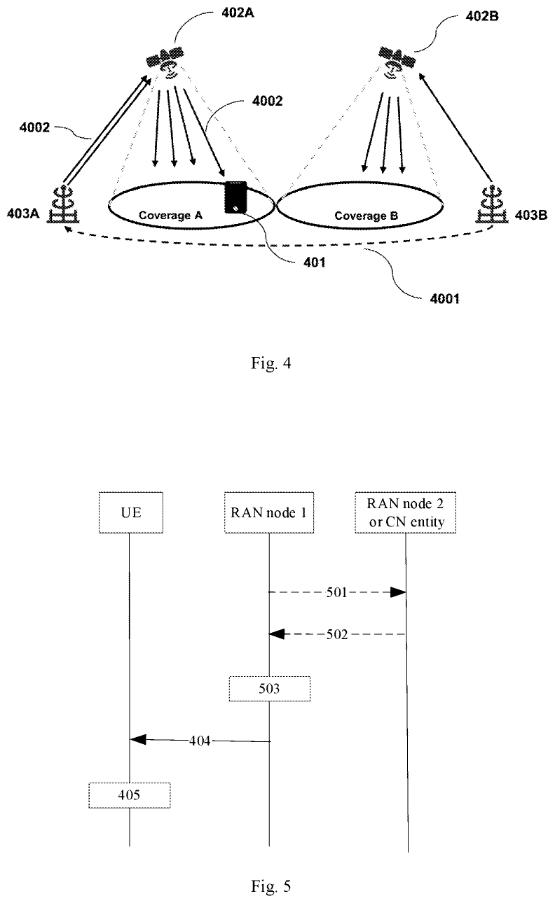

FIG. 4 illustrates a method for the UE to obtain the epoch time and validity time duration of the neighbor RAN node according to some embodiments of the present disclosure.

FIG. 4 illustrates a UE 401, a serving satellite 402A of the UE, a serving satellite 402B of the UE 401, a serving BS 403A, and a neighbor BS 403B. The coverage area A is covered by the serving satellite 402A, and the coverage area B is covered by the neighbor satellite 402B. Although in FIG. 4, the serving BS 403A (or neighbor BS 403B) and the serving satellite 402A (or neighbor satellite 402B) are located in different locations or apparatuses, in some other scenarios, the serving BS 403A (or neighbor BS 403B) and the serving satellite 402A (or neighbor satellite 402B) may be located in the same location or apparatus.

The serving BS 403A determines time information 4002 of the neighbor satellite 402B and transmits the same to the UE 401. Time information 4002 may be determined based on time information 4001 from the neighbor BS 403B or core network (CN) entity, or it is pre-stored in the serving BS 403A.

Hereinafter in the present disclosure, for simplification and clearness, the time information 4002 of the neighbor satellite or HAPS is referred to as the first time information, and the time information 4001 from BS 403B or CN entity, or pre-stored, is referred to as the second time information.

In this way, the UE 401 can obtain the time information of the neighbor satellite 402B even if not satisfying the above conditions 1)-3).

FIG. 5 illustrates a flow chart of an exemplary procedure of wireless communications according to some embodiments of the present disclosure.

FIG. 5 illustrates three components, a UE, RAN node 1, e.g., a satellite and RAN node 2, e.g., a terrestrial BS or a satellite acting as a BS or CN entity. RAN node 2 refers to a neighbor node of RAN node 1, which is a RAN node including the time information that RAN node 1 (or UE within the coverage of RAN node 1) needs, and has the second time information. The second time information may include at least one of the following:
1) a second epoch time associated with the ephemeris, common TA or feeder link propagation delay of RAN node 2;
2) a second validity time associated with the ephemeris, common TA or feeder link propagation delay of RAN node 2; or
3) at least one of a second reference time point for the second epoch time or second validity time associated with RAN node 2.

In some scenarios, RAN node 1 may not have the second time information associated with RAN node 2. In operation 501, if there are direct interfaces between RAN node 1 and RAN node 2, for example, inter-BS interfaces, such as S1 interface in LTE or NG interface in NR, RAN node 1 may transmit a request to RAN node 2.

If there are no direct interfaces, RAN node 1 may transmit the request to the CN entity, and request the second time information associated with RAN node 2 from the CN entity.

The request may include at least one of the following:
1) an indication to request for part or full of the second time information associated with RAN node 2;
2) an identity of RAN node 2; or
3) a preferred format of the second time information associated with RAN node 2.

In operation 502, after receiving the request, RAN node 2 or the CN entity transmits the second time information associated with RAN node 2 to RAN node 1.

The second time information associated with RAN node 2 may include at least one of: an second epoch time associated with the ephemeris, common TA, or feeder link propagation delay of RAN node 2; or include at least one of: an second validity time associated with the ephemeris, common TA, or feeder link propagation delay of RAN node 2; or include at least one of: an second epoch time associated with the ephemeris, an second validity time associated with the ephemeris, common TA, or feeder link propagation delay of RAN node 2.

Additionally, the second time information may also include at least one the second reference time point for the second epoch time or the second validity time associated with RAN node 2. If the second time information does not include the second reference time point, RAN node 1 considers that the second reference time point of RAN node 2 is the same as that of RAN node 1.

If the request from RAN node 1 includes the preferred format of the second time information associated with RAN node 2, RAN node 2 or the CN entity may convert the format of the second time information associated with RAN node 2 to the preferred format, and transmit the second time information in the preferred format to RAN node 1 in the response.

The format conversion may include converting the second time information from the relative time format to absolute time format. For the relative time format, the time value is represented by frame, subframe and slot numbers. For example, a time value may have a length of 500 frames, 3 subframes, and 1 slot. For the absolute time format, the time value is represented by milliseconds (ms). For example, the time value may have a length of 1000 ms.

The second time information associated with RAN node 2 represented by frame, subframe and slot numbers may include:
1) the second epoch time, T_{e2,frame}, which may be represented by at least one of three integers, the first integer represents the frame number of the second epoch time, and ranges from 0 to 1023, (i.e., integer (0 . . . 1023)); the second integer represents the subframe number of the second epoch time, and ranges from 0 to 9, (i.e., integer (0 . . . 9)), and the third integer represents the slot number of the second epoch time, and ranges from 0 to 24-1, (i.e., integer (0 . . . 2^{μ}−1)), wherein for NR, μ_RN2=0, 1, 2, 3, 4 corresponding to the 15, 30, 60, 120, 240 kHz of sub-carrier spacing (SCS) respectively, and for LTE, μ=1;
2) the second validity time, T_{v2,frame}, which may be represented in a similar fashion as the second epoch time with the at least one of the three integers; or
3) the second uplink time synchronization reference point, T_{ref,RN2}, with the unit of a millisecond.

RAN node 1 requests a preferred UTC time format of at least one of the second epoch time (i.e., T_{e2,UTC}) or the second validity time (i.e., T_{v2,UTC}) associated with RAN node 2. The second epoch time and the second validity time are integers with the range from 0 to 549755813887 ms, i.e., integer (0 . . . 549755813887).

The format conversion is calculated as follows:

$${T}_{e 2 , UTC} = {T}_{ref , RN 2} + ( 10 \times the frame number of {T}_{e 2 , frame} ) + the subframe number of {T}_{e 2 , frame} + ( {2}^{- μ} \times the slot number of {T}_{e 2 , frame} ) ; and \\ {T}_{v 2 , UTC} = {T}_{ref , RN 2} + ( 10 \times the frame number of {T}_{v 2 , frame} ) + the subframe number of {T}_{v 2 , frame} + ( {2}^{- μ} \times the slot number of {T}_{v 2 , frame} ) .$$

At least one of the parameters T_{e2,frame} or T_{v2,frame} may include frame, subframe and slot numbers, or frame and subframe numbers, or frame numbers only, or other combinations of frame, subframe and slot numbers, depending on its accuracy requirement.

In some other scenarios, RAN node 1 may have the second time information associated with RAN node 2, which is pre-stored in RAN node 1. For example, if the neighbor satellite or HAPS and the serving satellite (or HAPS) belong to the same BS, then the serving BS already have the second time information associated with neighbor satellite or HAPS. For another example, the serving BS and the neighbor BS associated with the neighbor satellite or HAPS are in the same network (e.g., the same public land mobile network (PLMN)). Referring to FIG. 4, BS 403A and BS 403B are all in the same network, in this case, BS 403A may pre-store the second time information associated with satellite 402B.

Based on the second time information associated with RAN node 2, RAN node 1 determines the first time information, which is also associated with RAN node 2, and transmits the first time information to the UE.

Due to different formats of the first time information and the second time information, the determination may include the conversion of different formats. The format conversion may include the following types:
1) absolute format to absolute format;
2) absolute format to relative format;
3) relative format to absolute format;
4) relative format to relative format; or
5) difference value between the first time information and the third time information associated with RAN node 1.

### Format Conversion Type 1:

Regarding format conversion type 1, the second time information is represented by absolute time value (e.g., UTC time) and RAN node 1 also uses the absolute time format for the first time information.

At least one of the second epoch time (referred to as T_{e2,UTC}) or the second validity time (referred to as T_{v2,UTC}) associated with RAN node 2 is represented by UTC time, which is an integer with the range from 0 to in 549755813887 ms, i.e., integer (0 . . . 549755813887) in milliseconds.

RAN node 1 determines that at least one of the first epoch time (referred to as T_{e1,UTC}) or the first validity time (referred to as T_{v1,UTC}) associated with RAN node 2 is represented by UTC time, which is an integer with the range from 0 to 549755813887 ms, i.e., integer (0 . . . 549755813887) in milliseconds.

Specifically, the conversion of the two parameters is calculated as follows:

$${T}_{e 1 , UTC} = {T}_{e 2 , UTC} + T ; \\ {T}_{v 1 , UTC} = {T}_{v 2 , UTC} .$$

Wherein T is the eclipsed time duration from T_{e2,UTC} to T_{e1,UTC}.

### Format Conversion Type 2:

Regarding format conversion type 2, the received second time information is represented by absolute time value (e.g., UTC time). RAN node 1 uses the relative time format based on the reference time of RAN node 1 (e.g., uplink time synchronization reference point of RAN node 1 or the epoch time associated with RAN node 1, such as point 1 or point 2 in FIG. 2A) and the time format (e.g., frame, sub-frame and slot number).

At least one of the second epoch time (i.e., T_{e2,UTC}) or the second validity time (i.e., T_{v2,UTC}) associated with RAN node 2 is represented by UTC time, which is an integer with the range from 0 to 549755813887 ms, i.e., integer (0 . . . 549755813887) in milliseconds.

RAN node 1 determines at least one of the first epoch time (i.e. T_{e1,frame}) or the first validity time (i.e. T_{v1,frame}) associated with RAN node 2, which may be represented by at least one of three integers. The first integer represents the frame number of the second epoch time, and ranges from 0 to 1023, (i.e. INTEGER (0 . . . 1023)); the second integer represents the subframe number of the second epoch time, and ranges from 0 to 9, (i.e. INTEGER (0 . . . 9)); and the third integer represents the slot number of the second epoch time, and ranges from 0 to 2^{μ}−1, (i.e. INTEGER (0 . . . 2^{μ}−1)), wherein for NR, μ=0, 1, 2, 3, 4 corresponding to the 15, 30, 60, 120, 240 kHz of SCS respectively, and for LTE, μ=1.

Specifically, the conversion of the two parameters is calculated as follows:

$$The frame number of {T}_{e 1 , frame} = Floor [ 0.1 \times ( {T}_{e 2 , UTC} - {T}_{ref , UTC} + T - {T}_{ref , R N 1} ) ] mod 1024 ; \\ The subframe number of {T}_{e 1 frame} = Floor ( {T}_{e 2 , UTC} - {T}_{ref , UTC} + T - {T}_{ref , RN 1} ) mod 10 ; \\ The slot number of {T}_{e 1 , frame} = Floor [ {2}^{μ} \times ( {T}_{e 2 , UTC} - {T}_{ref , UTC} + T - {T}_{ref , RN 1} ) ] mod ( {2}^{μ} \times 10 ) ; \\ The frame number of {T}_{v 1 , frame} = Floor [ 0.1 \times ( {T}_{v 2 , UTC} - {T}_{ref , UTC} - {T}_{ref , RN 1} ) ] mod 1024 ; \\ The subframe number of {T}_{v 1 , frame} = Floor ( {T}_{v 2 , UTC} - {T}_{ref , UTC} - {T}_{ref , RN 1} ) mod 10 ; \\ The slot number of {T}_{v 1 , frame} = Floor [ {2}^{μ} \times ( {T}_{v 2 , UTC} - {T}_{ref , UTC} - {T}_{ref , RN 1} ) ] mod ( {2}^{μ} \times 10 ) .$$

Where:
T is the eclipsed time duration from T_{e2,UTC} to T_{e1,frame};
T_{ref,UTC} is the reference UTC time 00:00:00 on Gregorian calendar date 1 Jan. 1900. This value is expressed in milliseconds;
T_{ref,RN1} is the uplink time synchronization reference point of RAN node 1;
For NR, μ=0/1/2/3/4 corresponding to the 15/30/60/120/240 kHz of SCS, respectively; for LTE μ=1;
T_{e1,frame} and/or T_{v1,frame} may include frame, subframe and slot numbers, frame and subframe numbers, frame numbers only, or other combinations of frame, subframe and slot numbers, depending on its accuracy requirement.

### Format Conversion Type 3:

Regarding format conversion type 3, the received second time information is represented by relative time value (e.g., frame, sub-frame and slot number) and reference time of RAN node 2 (e.g., uplink time synchronization reference point of RAN node 2). RAN node 1 could convert the relative time value into absolute time value (e.g., UTC time) based on the reference time of RAN node 1 (e.g., uplink time synchronization reference point of RAN node 1 or the epoch time associated with RAN node 1, such as point 1 or point 2 in FIG. 2A) and the time format (e.g. frame, sub-frame and slot number).

At least one of the second epoch time (i.e. T_{e2,frame}) or the second validity time (i.e. T_{v2,frame}) associated with RAN Node 2 may be represented by at least one of three integers. The first integer represents the frame number of the second epoch time, and ranges from 0 to 1023, (i.e., integer (0 . . . 1023)); the second integer represents the subframe number of the second epoch time, and ranges from 0 to 9, (i.e., integer (0 . . . 9)), and the third integer represents the slot number of the second epoch time, and ranges from 0 to 2^{μ}−1, (i.e., integer (0 . . . 2^{μ}−1)), wherein for NR, μ=0, 1, 2, 3, 4 corresponding to the 15, 30, 60, 120, 240 kHz of SCS respectively, and for LTE, μ=1, and uplink time synchronization reference point of RAN Node 2 is T_{ref,RN2}.

RAN Node 1 determines at least one of the first epoch time (i.e., T_{e1,UTC}) or the first validity time (i.e., T_{v1,UTC}) associated with RAN node 2 represented by UTC time. The value of T_{e1,UTC} and T_{v1,UTC} may be represented by an integer with the range from 0 to 549755813887 ms (i.e., integer (0 . . . 549755813887)).

Specifically, the format conversion is as follows:

$${T}_{e 1 , UTC} = {T}_{ref , RN 2} + ( 10 \times the frame number of {T}_{e 2 , frame} ) + the subframe number of {T}_{e 2 , frame} + ( {2}^{- μ} \times the slot number of {T}_{e 2 , frame} ) + T ; \\ {T}_{v 1 , UTC} = {T}_{ref , RN 2} + ( 10 \times the frame number of {T}_{v 2 , frame} ) + the subframe number of {T}_{v 1 , frame} + ( {2}^{- μ} \times the slot number of {T}_{v 2 , frame} ) ;$$

Where:
T is the eclipsed time duration from T_{e2,frame} to T_{e1,UTC};
For NR, μ=0/1/2/3/4 corresponding to the 15/30/60/120/240 kHz of SCS, respectively; for LTE μ=1;
T_{e2,frame} or T_{v2,frame} may include frame, subframe and slot numbers, frame and subframe numbers, frame numbers only, or other combinations of frame, subframe and slot numbers, depending on its accuracy requirement.

### Format Conversion Type 4:

Regarding format conversion type 4, the second time information is represented in the relative time format, and RAN node 1 converts the relative time value into relative time value based on the reference time of RAN node 1 (e.g., uplink time synchronization reference point of RAN node 1 or the epoch time associated with RAN node 1, such as point 1 or point 2 in FIG. 2A) and the time format (e.g., frame, sub-frame and slot number).

At least one of the second epoch time (i.e. T_{e2,frame}) or the second validity time (i.e. T_{v2,frame}) associated with RAN node 2 may be represented by at least one of three integers. The first integer represents the frame number of the second epoch time, and ranges from 0 to 1023, (i.e. integer (0 . . . 1023)); the second integer represents the subframe number of the second epoch time, and ranges from 0 to 9, (i.e. integer (0 . . . 9)), and the third integer represents the slot number of the second epoch time, and ranges from 0 to 2^{μ_RN2}−1, (i.e. integer (0 . . . 2^{μ_RN2}−1)), wherein for NR, μ_RN2=0, 1, 2, 3, 4 corresponding to the 15, 30, 60, 120, 240 kHz of SCS respectively, and for LTE, μ_RN2=1, and uplink time synchronization reference point of RAN node 2 is T_{ref,RN2}.

RAN node 1 determines that at least one of the first epoch time (i.e. T_{e1,frame}) or the first validity time (i.e. T_{v1,frame}) associated with RAN node 2 may be represented by at least one of three integers. The first integer represents the frame number of the second epoch time, and ranges from 0 to 1023, (i.e. integer (0 . . . 1023)); the second integer represents the subframe number of the second epoch time, and ranges from 0 to 9, (i.e. integer (0 . . . 9)), and the third integer represents the slot number of the second epoch time, and ranges from 0 to 2^{μ_RN1}−1, (i.e. integer (0 . . . 2^{μ_RN1}−1)), wherein for NR, μ_RN1=0, 1, 2, 3, 4 corresponding to the 15, 30, 60, 120, 240 kHz of SCS respectively, and for LTE, μ_RN1=1, and uplink time synchronization reference point of RAN node 1 is T_{ref,RN1}.

Specifically, the format conversion is as follows:

$$The frame number of {T}_{e 1 , frame} = Floor \{ 0.1 \times [ {T}_{ref , RN 2} + ( 10 \times the frame number of {T}_{e 2 , frame} ) + the subframe number of {T}_{e 2 , frame} + ( {2}^{- μ\_ RN 2} \times the slot number of {T}_{e 2 , frame} ) + T - {T}_{ref , RN 1} ] \} mod 1024 ; \\ The subframe number of {T}_{e 1 , frame} = Floor [ {T}_{ref , RN 2} + ( 10 \times the frame number of {T}_{e 2 , frame} ) + the subframe number of {T}_{e 2 , frame} + ( {2}^{- μ\_ RN 2} \times the slot number of {T}_{e 2 , frame} ) + T - {T}_{ref , RN 1} ] mod 10 ; \\ The slot number of {T}_{e 1 , frame} = Floor \{ {2}^{μ} \times [ {T}_{ref , RN 2} + ( 10 \times the frame number of {T}_{e 2 , frame} ) + the subframe number of {T}_{e 2 , frame} + ( {2}^{- μ\_ RN 2} \times the slot number of {T}_{e 2 , frame} ) + T - {T}_{ref , RN 1} ] \} mod ( {2}^{μ\_ RN 1} \times 10 ) ; \\ The frame number of {T}_{v 1 , frame} = Floor \{ 0.1 \times [ {T}_{ref , RN 2} + ( 10 \times the frame number of {T}_{v 2 , frame} ) + the subframe number of {T}_{v 2 , frame} + ( {2}^{- μ\_ RN 2} \times the slot number of {T}_{v 2 , frame} ) - {T}_{ref , RN 1} ] \} mod 1024 ; \\ The subframe number of {T}_{v 1 , frame} = Floor [ {T}_{ref , RN 2} + ( 10 \times the frame number of {T}_{v 1 , frame} ) + the subframe number of {T}_{v 1 , frame} + ( {2}^{- μ\_ RN 2} \times the slot number of {T}_{v 1 , frame} ) - {T}_{ref , RN 1} ] mod 10 ; \\ The slot number of {T}_{v 1 , frame} = Floor \{ {2}^{μ} \times [ {T}_{ref , RN 2} + ( 10 \times the frame number of {T}_{v 1 , frame} ) + the subframe number of {T}_{v 1 , frame} + ( {2}^{- μ\_ RN 2} \times the slot number of {T}_{v 1 , frame} ) - {T}_{ref , RN 1} ] \} mod ( {2}^{μ\_ RN 1} \times 10 ) .$$

Where:
T is the time duration from T_{e1,frame} to the uplink time synchronization reference time point of RAN node 1, i.e. T_{ref,RN1};
T_{ref,RN1} is uplink time synchronization reference point of RAN node 1;
μ_RN1 and μ_RN2 may be the same of different depending on the air interface protocols they use, respectively; and
T_{e1,frame}, T_{v1,frame}, T_{e2,frame} or T_{v2,frame} may include frame, subframe and slot numbers, or frame and subframe numbers, frame numbers only, or other combinations of frame, subframe and slot numbers, depending on its accuracy requirement.

### Format Conversion Type 5:

Similar to the second time information associated with RAN node 2, RAN node 1 includes the third time information, which may include at least one of the following:
1) a third epoch time associated with the ephemeris or the common TA of RAN node 1;
2) a third validity time associated with the ephemeris or the common TA of RAN node 1; or
3) a third reference time point for the third epoch time and/or third validity time associated with RAN node 1.

Regarding format conversion type 5, RAN node 1 provides the first time information associated with RAN node 2 together with the third time information associated with RAN node 1, and the first time information associated with RAN node 2 is provided to the UE by difference values compared to the third information associated with RAN node 1.

The epoch time (i.e. T_{e3,frame}) and the validity time (i.e. T_{v3,frame}) associated with RAN node 1 are represented by frame and subframe numbers may be represented by at least one of two integers. The first frame number is an integer with the range from 0 to 1023, (i.e. integer (0 . . . 1023)); and the second subframe number is an integer with the range from 0 to 9, (i.e. integer (0 . . . 9)), as specified by 3GPP documents. The uplink time synchronization reference point of RAN node 1 is referred to as T_{ref,RN1}. RAN node 1 determines that at least one of the first epoch time or the first validity time associated with RAN node 2 is represented by at least one of the difference values T_{e1,diff} or T_{v1,diff} in milliseconds compared with T_{e3,frame} and T_{v3,frame}.

Specifically, at least one of the difference values T_{e1,diff} or T_{v1,diff} are calculated as follows:

If the first time information and the first time information are represented by UTC format, the format conversion is as follows:

$${T}_{e 1 , diff} = {T}_{e 1 , UTC} - [ {T}_{ref , RN 1} + ( 10 \times the frame number of {T}_{e 3 , frame} ) + the subframe number of {T}_{e 3 , frame} ] ; \\ {T}_{v 1 , diff} = {T}_{v 1 , UTC} - [ {T}_{ref , RN 1} + ( 10 \times the frame number of {T}_{v 3 , frame} ) + the subframe number of {T}_{v 3 , frame} ] .$$

If the first time information and the first time information are represented by relative format, the format conversion is as follows:

$${T}_{e 1 , diff} = [ \text{} ( 10 \times the frame number of {T}_{e 1 , frame} ) + the subframe number of {T}_{e 1 , frame} + ( {2}^{- μ} \times the slot number of {T}_{e 1 , frame} ) ] - \text{} [ \text{} ( 10 \times the frame number of {T}_{e 3 , frame} ) + the subframe number of {T}_{e 3 , frame} ] ; \\ {T}_{v 1 , diff} = [ ( 10 \times the frame number of {T}_{v 1 , frame} ) + the subframe number of {T}_{v 1 , frame} + ( {2}^{- μ} \times the slot number of {T}_{v 1 , frame} ) ] - [ \text{} ( 10 \times the frame number of {T}_{v 3 , frame} ) + the subframe number of {T}_{v 3 , frame} ] .$$

Where
T_{ref,RN1} is uplink time synchronization reference point of RAN node 1;
For NR, μ=0/1/2/3/4 corresponding to the 15/30/60/120/240 kHz of SCS, respectively; for LTE μ=1;
μ_RN1 and μ_RN2 may be the same of different depending on the air interface protocols they use, respectively; and
T_{e1,frame} and/or T_{v1,frame} is the first epoch time and/or the first validity time associated with RAN node 2, and may include frame, subframe and slot numbers, frame and subframe numbers, frame numbers only, or other combinations of frame, subframe and slot numbers, depending on its accuracy requirement.

In some other scenarios, the epoch time (and/or validity time) of RAN node 2 shares the epoch time (and/or validity time) of the RAN node 1, which means that they have the same values and parameters. In other words, the first epoch time (and/or the first validity time) of RAN node 2 are identical to the third epoch time (and/or the third validity time) of RAN node 1 respectively. In this case, the first epoch time (and/or the first validity time) of RAN node 2 may be absent of set to default in the first time information that is to be transmitted to the UE.

After determining the first time information associated with RAN node 2, in operation 504, RAN node 1 transmits the first time information to UE via SI broadcast, on-demand SI, dedicated signaling, or other messages.

The first time information associated with RAN node 2 may include at least one of the following:
1) The first epoch time associated with the ephemeris, common TA or feeder link propagation delay of RAN node 2. If it is absent or set to default, the first epoch time is the same as the third epoch time associated with RAN node 1;
2) The first validity time associated with the ephemeris, common TA or feeder link propagation delay of RAN node 2. If absent or set to default, the first validity time is the same as the third validity time associated with RAN node 1;
3) The first reference time point for at least one of the first epoch time or the first validity time associated with RAN node 2. If it is absent or set to default, the first reference time point for at least one of the first epoch time or the first validity time associated with RAN node 2 is the same as the third reference time point for at least one of the third epoch time or the third validity time associated with RAN node 1;
4) An indication indicating that the first epoch time or validity time associated with RAN node 2 is shared by the ephemeris, common TA or feeder link propagation delay of RAN node 2;
5) An indication indicating that the first epoch time or validity time associated with RAN node 2 is the same as that associated with RAN node 1; or
6) An indication indicating that the first reference time point associated with RAN node 2 is the same as that associated with RAN node 1.

In some embodiments, the first epoch time may be represented by UTC time format, alternatively, the first epoch time may be represented by relative format, or maybe a relative time with reference time point, e.g., represented by frame, subframe and slot numbers, or milliseconds. When indicated in SIB other than SIB1, as shown in FIG. 2B, the epoch time may be the end of the SI window during which the SI message is transmitted.

In some embodiments, the first validity time may be in the form of an absolute time, e.g. represented by UTC time format. Before the first validity time expires, the associated ephemeris, common TA or feeder link propagation delay value is considered as valid. Alternatively, the first validity time may be in the form of a relative time duration with a reference time point, e.g. represented by frame, subframe and slot numbers, or milliseconds, during which the associated ephemeris, common TA or feeder link propagation delay value are considered as valid.

In some embodiments, the third reference time point may be between the serving BS and the satellite, in the case that the serving BS and the satellite are located at different locations, or may be at the serving BS, at the satellite, or at the UE, or at the epoch time associated with the serving BS. For example, it may be the uplink time synchronization reference point of RAN node 1, such as point 1 in FIG. 2A, or may be at the serving BS, at the satellite, or at the UE, or at the epoch time associated with the serving BS (i.e., point 2 in FIG. 2A). In the case that the serving BS and the satellite are located at the same location, the location of between the serving BS and the satellite, the serving BS, and the satellite refer to the same location.

In operation 505, based on the received first time information associated with RAN node 2, the UE determines the time-related status of RAN node 2.

The time-related status at least includes two parts, the spatial status, and the temporal status.

The determination of spatial status may include at least one of the following:
The UE determines the parameter values of RAN node 2 (for example, ephemeris) associated with the received first time information as the values at the first epoch time Tₑ₁.

The UE determines the parameter values of RAN node 2 (for example, ephemeris) associated with the received first time information as valid before the first validity time or during the second validity time duration starting at the first epoch time Tₑ₁.

The UE calculates the coordinates of RAN node 2 (i.e. (X_{target}, Y_{target}, Z_{target})) at a target time T_{target} based on the coordinates and its epoch time received in the time information as follows:

$${X}_{target} = {X}_{received} + Δ {X}_{received} \times ( {T}_{target} - {T}_{e 1} ) ; \\ {Y}_{target} = {Y}_{received} + Δ {Y}_{received} \times ( {T}_{target} - {T}_{e 1} ) ; and \\ {Z}_{target} = {Z}_{received} + Δ {Z}_{received} \times ( {T}_{target} - {T}_{e 1} ) ;$$

Wherein (X_{received}, Y_{received}, Z_{received}) and (ΔX_{received}, ΔY_{received}, ΔZ_{received}) are the coordinates and velocity of RAN node 2 at the first epoch time Tₑ₁, respectively.

UE calculates the orbital position of RAN node 2 at a target time T_{target} based on the orbital position and its epoch time received in the time information. The orbital position of RAN node 2 at the target time T_{target} is calculated as follows:

$${M}_{target} = {M}_{received} + {( Gm / {α}^{3} )}^{∧} ( 1 / 2 ) \times ( {T}_{target} - {T}_{e 1} )$$

### Wherein

M_{received} is the orbital position of RAN node 2 at the first epoch time Tₑ₁;
α is the semi-major axis in RAN node 2 ephemeris;
G is the Gravitational constant; and
m is the Earth mass and Gm≈398601 km³/s³.

The determination of temporal status may include at least one of the following:

The UE may determine that the parameter values of RAN node 2 (e.g. common TA feeder link propagation delay) associated with the received first time information as the values at the first epoch time.

The UE may determine that the parameter values of RAN node 2 (e.g., common TA feeder link propagation delay) associated with the received first time information as valid before the first validity time or during the first validity time duration starting at the first epoch time.

The UE may start a validity timer for the parameter values in the received first time information when received. The length of the validity timer is:

$${L}_{ValidityTimer} = {T}_{v 1 , UTC} - {T}_{current , UTC} \\ {L}_{ValidityTimer} = {T}_{v 1 , frame} - ( {T}_{current , frame} - {T}_{e 2 , frame} )$$

Wherein T_{current,UTC} and T_{current,frame} are the current time (i.e. reception time) in UTC format or relative format, respectively.

In some embodiments, the UE may discard the above parameter values in the received first time information as well as any calculation result, after the first validity time, or after the expiration of the first validity timer, which is included in the first time information associated with RAN node 2.

In some embodiments, the UE may request for another time information associated with RAN node 2 after the first validity time, or after expiration of the first validity timer.

The common TA of the RAN node 2 at the target time T_{target} is calculated as follows:

$${TA}_{common , target} = {TA}_{common , received} + Δ {TA}_{common , received} \times ( {T}_{target} - {T}_{e 1} )$$

Wherein TA_{common,received} and ΔTA_{common,received} are the common TA value and changing rate of RAN node 2 at the first epoch time Tₑ₂, respectively.

The feeder link delay of the RAN node 2 at target time T_{target} is calculated as follows:

$${FL}_{delay , target} = {FL}_{delay , received} + Δ {FL}_{delay , received} \times ( {T}_{target} - {T}_{e 1} )$$

Wherein FL_{delay, received} and ΔFL_{delay, received} are the feeder link delay value and changing rate of RAN node 2 at the first epoch time Tₑ₁, respectively.

The propagation delay between UE and RAN node 2 SL_{delay, target} is calculated as follows:

$${SL}_{delay , target} = {[ {( {X}_{target} - {X}_{UE} )}^{2} + {( {Y}_{target} - {Y}_{UE} )}^{2} + {( {Z}_{target} - {Z}_{UE} )}^{2} ]}^{1 / 2} / c$$

Wherein (X_{UE}, Y_{UE}, Z_{UE}) is UE position and c is light speed.

Or, the propagation delay may be calculated as follows:

$${SL}_{delay , target} = [ α \times {( 1 - {e}^{2} {sin}^{2} {M}_{target} )}^{1 / 2} - {R}_{Earth} ] / c$$

Wherein c is light speed and R_{Earth} is the average radius of Earth.

With the above solutions, the UE can obtain the time information of RAN node 2, which may be a neighbor RAN node, or a nearby RAN node, or any other RAN node.

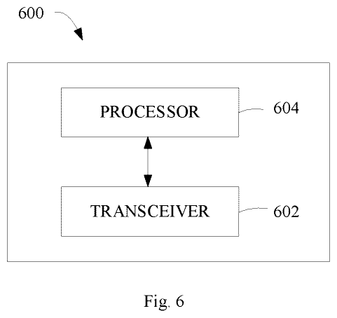

FIG. 6 illustrates a block diagram of an exemplary apparatus 600 according to some embodiments of the present disclosure. As shown in FIG. 6, the apparatus 600 may include at least one processor 604 and at least one transceiver 602 coupled to the processor 604. The apparatus 600 may be a UE or a BS.

Although in this figure, elements such as the at least one transceiver 602 and processor 604 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 604 may interact with each other so as to perform the operations with respect to the UE described above, for example, in FIGS. 1-5.

In some embodiments of the present disclosure, the apparatus 600 may be a BS. The transceiver 602 and the processor 604 may interact with each other so as to perform the operations with respect to the BS described above, for example, in FIGS. 1-5.

In some embodiments of the present disclosure, the apparatus 600 may further include at least one non-transitory computer-readable medium. For example, in some embodiments of the present disclosure, the non-transitory computer-readable medium may have stored thereon computer-executable instructions to cause the processor 604 to implement the method with respect to the UE as described above. For example, the computer-executable instructions, when executed, cause the processor 604 interacting with transceiver 602 to perform the operations with respect to the UE described in FIGS. 1-5.

In some embodiments of the present disclosure, the apparatus 600 may further include at least one non-transitory computer-readable medium. For example, in some embodiments of the present disclosure, the non-transitory computer-readable medium may have stored thereon computer-executable instructions to cause the processor 604 to implement the method with respect to the BS as described above. For example, the computer-executable instructions, when executed, cause the processor 604 interacting with transceiver 602 to perform the operations with respect to the BS described in FIGS. 1-5.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A radio access network (RAN) node for wireless communication, comprising:
at least one memory; and
at least one processor coupled with the at least one memory and configured to cause the RAN node to:
determine first time information associated with a neighbor RAN node of the RAN node; and
transmit the first time information to a user equipment (UE), wherein the first time information includes at least one of:
a first epoch time associated with the neighbor RAN node; or
a first validity time associated with the neighbor RAN node.

2. The RAN node of claim 1, wherein the first time information is determined based on second time information of the neighbor RAN node, wherein the second time information at least comprises one of:
a second epoch time associated with the neighbor RAN node; or
a second validity time associated with the neighbor RAN node.

3. The RAN node of claim 2, wherein the second time information is one or more of pre-stored in the RAN node, or received from the neighbor RAN node in response to a request from the RAN node to the neighbor RAN node.

4. The RAN node of claim 3, wherein the request comprises at least one of:
an indication to request a part of the second time information or all of the second time information;
an identity of the neighbor RAN node; or
a preferred format of the second time information.

5. The RAN node of claim 2, wherein the first time information is represented in a first format, the second time information is represented in a second format, and the processor is further configured to cause the RAN node to:
convert the second time information in the second format to the first time information in the first format.

6. The RAN node of claim 1, wherein at least one of the first epoch time or the first validity time is associated with at least one of:
an ephemeris of the neighbor RAN node;
a common timing advance (TA) of the neighbor RAN node; or
a feeder link propagation delay of the neighbor RAN node.

7. The RAN node of claim 1, wherein the first time information further comprises a first reference time point for at least one of the first epoch time or the first validity time.

8. The RAN node of claim 1, wherein the first time information is transmitted to the UE by a system information (SI) broadcast, an on-demand SI, or a dedicated signaling.

9. The RAN node of claim 1, wherein the first time information indicates at least one of:
the first epoch time has a same value as a third epoch time associated with the RAN node, wherein the third epoch time is associated with at least one of an ephemeris of the RAN node or a common TA of the RAN node; or
the first validity time has a same value as a third validity time associated with the RAN node, wherein the third validity time is associated with at least one of an ephemeris of the RAN node or a common TA of the RAN node.

10. A user equipment (UE) for wireless communication, comprising:
at least one memory; and
at least one processor coupled with the at least one memory and configured to cause the UE to:
receive, from a radio access network (RAN) node, first time information associated with a neighbor RAN node of the RAN node; and
determine time-related status of the neighbor RAN node based on the first time information, wherein the first time information includes at least one of:
a first epoch time associated with the neighbor RAN node; or
a first validity time associated with the neighbor RAN node.

11. The UE of claim 10, wherein at least one of the first epoch time or the first validity time is associated with at least one of:
an ephemeris of the neighbor RAN node;
a common timing advance (TA) of the neighbor RAN node; or
a feeder link propagation delay of the neighbor RAN node.

12. The UE of claim 10, wherein the first time information further comprises a first reference time point for at least one the first epoch time or the first validity time.

13. The UE of claim 10, wherein the first time information is received by a system information (SI) broadcast, an on-demand SI, or a dedicated signaling.

14. The UE of claim 11, wherein the time-related status of the neighbor RAN node comprises at least one of:
at least one of the ephemeris, the common TA, or the feeder link propagation delay at the first epoch time;
at least one of the ephemeris, the common TA, or the feeder link propagation delay that is valid;
at least one of the ephemeris, the common TA, or the feeder link propagation delay at a given time;
coordinates of the neighbor RAN node at a given time;
an orbital position of the neighbor RAN node at a given time;
a validity timer for the neighbor RAN node parameter values that is started the first time information is received;
a length of the validity timer from reception time to the first validity time;
the first epoch time has a same value as a third epoch time associated with the RAN node, wherein the third epoch time is associated with at least one of an ephemeris of the RAN node or a common TA of the RAN node; or
the first validity time has a same value as a third validity time associated with the RAN node, wherein the third validity time is associated with at least one of an ephemeris of the RAN node or a common TA of the RAN node.

15. The UE of claim 10, wherein in a case that the first time information comprises the first validity time, the at least one processor is further configured to cause the UE to at least one of:
discard received first time information associated with the neighbor RAN node when the first validity time expires;
discard determined time-related status based on the first time information when the first validity time expires;
consider UE uplink synchronization to the neighbor RAN node lost; or
request for updating the first time information associated with the neighbor RAN node when the first validity time expires.

16. A processor for wireless communication, comprising:
at least one controller coupled with at least one memory and configured to cause the processor to:
receive, from a radio access network (RAN) node, first time information associated with a neighbor RAN node of the RAN node; and
determine time-related status of the neighbor RAN node based on the first time information, wherein the first time information includes at least one of:
a first epoch time associated with the neighbor RAN node; or
a first validity time associated with the neighbor RAN node.

17. The processor of claim 16, wherein at least one of the first epoch time or the first validity time is associated with at least one of:
an ephemeris of the neighbor RAN node;
a common timing advance (TA) of the neighbor RAN node; or
a feeder link propagation delay of the neighbor RAN node.

18. The processor of claim 17, wherein the time-related status of the neighbor RAN node comprises at least one of:
at least one of the ephemeris, the common TA, or the feeder link propagation delay at the first epoch time;
at least one of the ephemeris, the common TA, or the feeder link propagation delay that is valid;
at least one of the ephemeris, the common TA, or the feeder link propagation delay at a given time;
coordinates of the neighbor RAN node at a given time;
an orbital position of the neighbor RAN node at a given time;
a validity timer for neighbor RAN node parameter values that is started the first time information is received;
a length of the validity timer from reception time to the first validity time;
the first epoch time has a same value as a third epoch time associated with the RAN node, wherein the third epoch time is associated with at least one of an ephemeris of the RAN node or a common TA of the RAN node; or
the first validity time has a same value as a third validity time associated with the RAN node, wherein the third validity time is associated with at least one of an ephemeris of the RAN node or a common TA of the RAN node.

19. The processor of claim 16, wherein the first time information is received by a system information (SI) broadcast, an on-demand SI, or a dedicated signaling.

20. A method performed by a user equipment (UE), the method comprising:
receiving, from a radio access network (RAN) node, first time information associated with a neighbor RAN node of the RAN node; and
determining time-related status of the neighbor RAN node based on the first time information, wherein the first time information includes at least one of:
a first epoch time associated with the neighbor RAN node; or
a first validity time associated with the neighbor RAN node.
